(19) United States
(12) Patent Application Publication
(10) Pub. No.: US 2005/0017080 A1
(43) Pub. Date: Jan. 27, 2005

(54) Special usable pocket

(76) Inventors: Nancy Gold, Niskayuna, NY (US); Inna Spektor, Niskayuna, NY (US); Ronald A. Dingman, Schenectady, NY (US)

Correspondence Address: HOFFMAN WARNICK & D'ALESSANDRO, LLC, 3 E-COMM SQUARE, ALBANY, NY, 12207, US

(21) Appl. No.: 10/894,581

(22) Filed: Jul. 20, 2004

Related U.S. Application Data
(60) Provisional application No. 60/488,903, filed on Jul. 21, 2003.

(51) Int. Cl. G06K 7/00

(52) U.S. Cl. 235/486

(57) ABSTRACT

The present invention provides a pocket for housing a device, wherein the device may be used while within the pocket. Specifically, the pocket includes an aperture permitting observation and/or manipulation of the device interface while it remains within the pocket. The pocket may optionally include a means for securing the interface portion of the device within the pocket and/or a flexible member covering the aperture. The pocket may be attached to a carrying apparatus, wearable object, or the like.

### CROSS REFERENCE TO RELATED APPLICATIONS

The current application claims the benefit of co-pending U.S. Provisional Application No. 60/488,903 filed Jul. 21, 2003, which is hereby incorporated herein by reference.

### BACKGROUND OF THE INVENTION

(1) Technical Field

The present invention relates generally to pockets for equipment and more particularly to a pocket capable of securing an interface portion of a device and permitting use of the device without its removal from the pocket.

(2) Related Art

Enclosures for devices, and particularly those for electronic devices, are known in the art. Such enclosures may be composed of hard or soft materials and may be incorporated into other components, such as clothing or luggage, or may be used independently.

Many such enclosures, however, are suitable only for the transportation or temporary protection of the devices they house. That is, most require that the device be removed from the enclosure prior to its use. Thus, the protection afforded by such enclosures is lost while the device is actually in use. With many devices, such as electronic metering equipment, it is this period of use when protection from environmental and other hazards is most desirable.

Thus, a need exists for an enclosure that allows for transportation and/or protection of a device while simultaneously permitting use of the device within the enclosure.

### SUMMARY OF THE INVENTION

The present invention provides a pocket for housing a device, wherein the device may be used while within the pocket. Specifically, the pocket includes an aperture permitting observation and/or manipulation of the device interface while it remains within the pocket. The pocket may optionally include a means for securing the interface portion of the device within the pocket and/or a flexible member covering the aperture. The pocket may be attached to a carrying apparatus, wearable object, or the like.

A first embodiment of the invention provides a carrying apparatus comprising a first storage means and a second storage means capable of housing an interface portion of a device, the second storage means comprising a body capable of substantially enclosing the interface portion of the device and an aperture permitting use of the interface portion when it is within the second storage means.

A second embodiment of the invention provides a wearable article comprising a means for securing the article to a user and a means for housing an interface portion of a device, the means comprising a body capable of substantially enclosing the interface portion and an aperture permitting use of the interface portion when it is within the means for housing.

A third embodiment of the invention provides a storage means comprising a body capable of substantially enclosing an interface portion of a device, a first aperture permitting use of the interface portion when it is within the body, and a second aperture permitting passage of an element of the device that is fixed to the interface portion to a location outside the body.

The foregoing and other features of the invention will be apparent from the following more particular description of various embodiments of the invention.

### BRIEF DESCRIPTION OF THE DRAWINGS

Illustrative embodiments of this invention will be described in detail, with reference to the following figures, wherein like designations denote like elements, and wherein:

FIG. 1 shows a bag according to a first embodiment of the invention.

FIG. 2 shows a pocket according to the invention.

FIG. 3 shows a bag according to a second embodiment of the invention with a first portion of a device contained within the pocket and a second portion of the device attached to the outside of the bag.

FIG. 4 shows a vest having a pocket according to a third embodiment of the invention.

FIG. 5 shows a pocket according to a fourth embodiment of the invention.

### DETAILED DESCRIPTION OF THE INVENTION

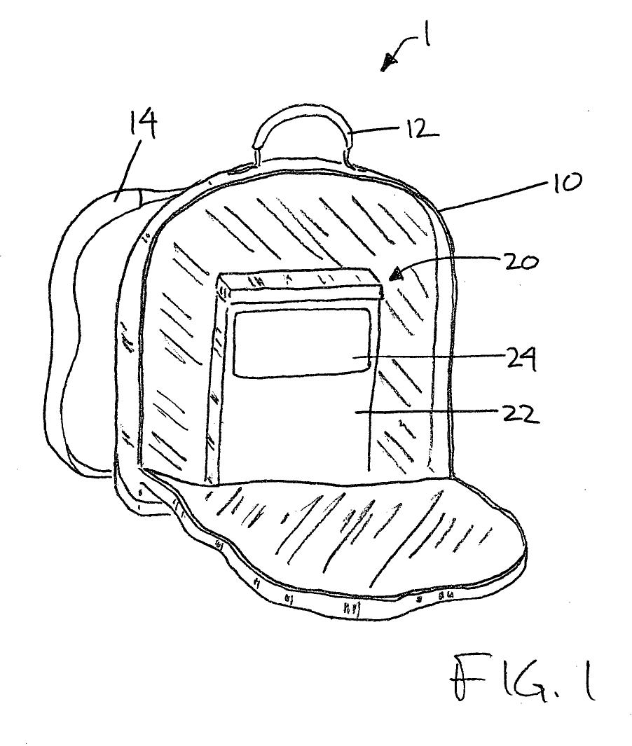

Referring to FIG. 1, a bag 1 according to a first embodiment of the invention is shown. Bag 1 includes a bag body 10 and a pocket 20 capable of housing a device. Pocket 20 comprises a pocket body 22 and at least one aperture 24. Bag 1 may optionally include other components, such as handles 12 and straps 14, making bag 1 useful as a backpack, messenger bag, handbag, shoulder bag, tote bag, duffle bag, fanny pack or similar article.

Bag body 10 and pocket 20 can be of any material or combination of materials known in the art, such as cotton, leather, silk, nylon, or polyester. To this extent, bag body 10 and pocket 20 may be of the same material or different materials. Further, bag body 10 and pocket 20 may be fixedly attached, as with stitching or adhesives, or non-fixedly attached, as with zippers, snaps, buttons, clips, straps, hook-and-loop members, and the like. Still further, while pocket 20 is depicted on an interior surface of bag body 10, it may also be located on an exterior surface.

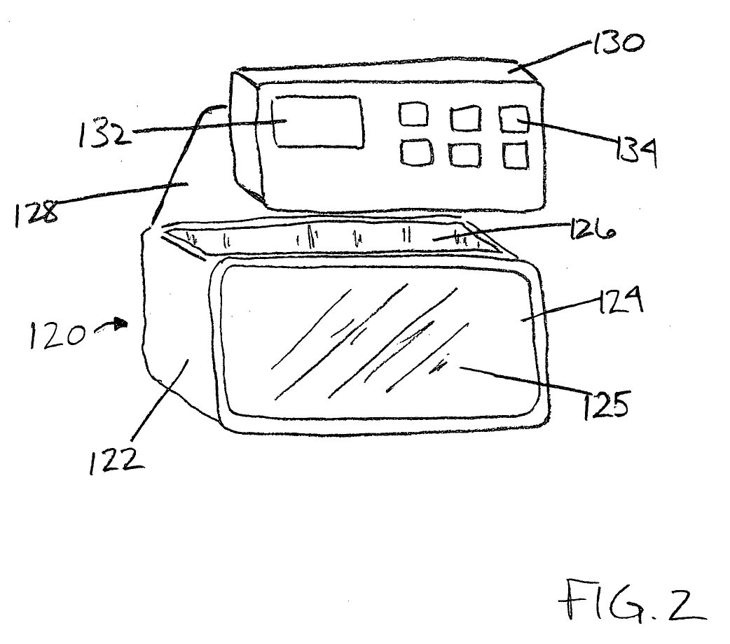

Referring to FIG. 2, pocket 120 and a device 130 are shown. Device 130 is inserted into pocket 120 through an opening 126 in pocket body 122. Pocket body 122 includes a securing member 128, shown as a lid, capable of securing device 130 within pocket 120. Securing member 128 may be fastened at its free end to pocket body 122 by any number of means known in the art, including hooks-and-loops, snaps, buttons, clips, webs, zippers, loops, and elastics. Where pocket 120 and device 130 are of substantially the same size, use of securing member 128 may be unnecessary. That is, device 130 may be secured within pocket 120 simply by means of the contact of device 130 with the interior of pocket body 122.

As depicted, pocket body 122 further includes a flexible member 125 covering aperture 124. Flexible member 125 provides additional protection to device 130 while still permitting observation and/or manipulation of its interface components, such as a display 132 and button 134. Flexible member 125 may be of any material known in the art, such as fabric mesh, vinyl, silicone, polyethylene, or polystyrene. In one embodiment, flexible member 125 is substantially transparent.

In one embodiment, the apparatus of the present invention can be configured as an article to be worn by a user. Such articles include items of clothing, such as vests, coats, jackets, shirts, and pants, and may also include carrying devices configured to be worn by a user. Often, such carrying devices are configured to be worn on or around a user's torso, such as backpacks, messenger bags, and shoulder bags, but may also be configured as an article to be worn on or around other parts of a user's body, such as a fanny pack. FIGS. 1, 3 and 4 show illustrative embodiments of the invention that are configured to be worn by a user.

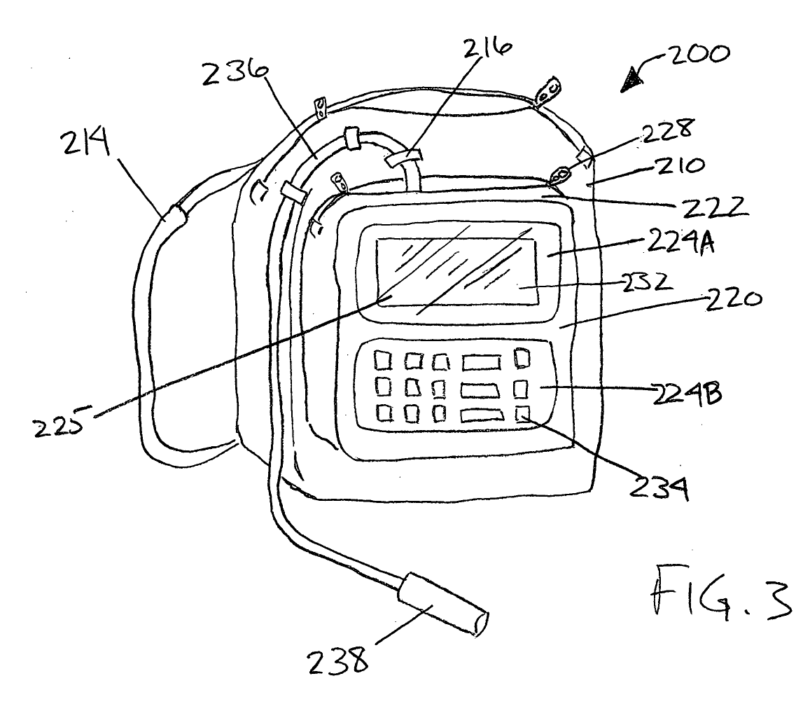

Referring to FIG. 3, bag 200 is depicted as a backpack comprising a bag body 210 and a pocket 220. Bag body 210 includes at least one strap 214 suitable for carrying bag 200 over a user's shoulders. Pocket body 222 includes two apertures 224A-B. The top aperture 224A can be covered by a flexible member 225 for protection of a display 232. The bottom aperture 224B can be open, permitting manipulation of buttons 234. Pocket body 222 includes securing member 228, depicted as a zipper.

Some devices, such as metering equipment, may require a portion of the device to reside outside pocket 220. It may also be necessary or helpful to partially or completely restrain the portion of the device residing outside pocket 220. In such a case, bag body 210 may further include device securing members 216 capable of securing a portion of the device not contained within pocket 220 to bag body 210. As depicted, a cable 236 and a sensor 238 of the device extend outside pocket 220. Device securing members 216 attach a portion of cable 236 to bag body 210. Device securing member 216 may be any apparatus or combination known in the art, including hooks-and-loops, snaps, buttons, clips, webs, zippers, loops, and elastics.

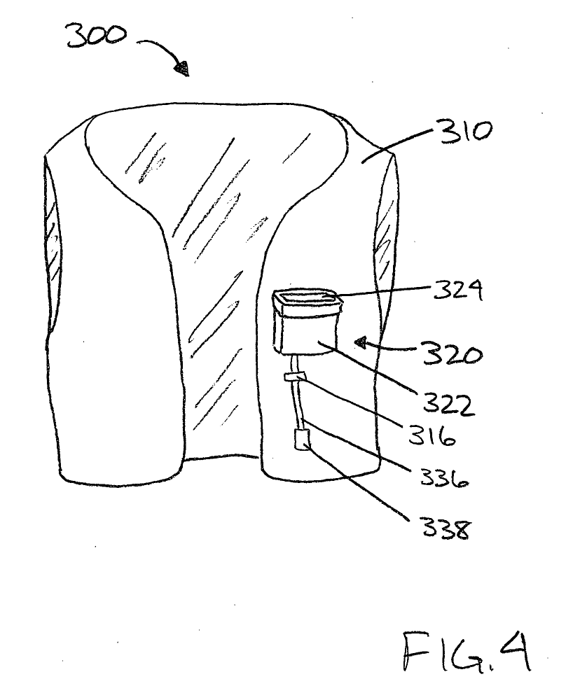

Referring to FIG. 4, vest 300 comprises a vest body 310 and a pocket 320. Pocket 320 comprises a pocket body 322 and an aperture 324. As depicted, aperture 324 faces substantially upward, permitting the wearer to observe and/or manipulate a device contained within pocket 320.

Optionally, where a portion of the device resides outside pocket 320, device securing members 316 may be used to attach a portion of the device to vest body 310. As depicted, cable 336 and sensor 338 are attached to vest body 310 by device securing member 316. Device securing members 316 may be located on a portion of the device, vest body 310, or both.

Although depicted as a vest, any wearable article may similarly be used. In one embodiment, the article is one that may be worn around a user's torso, such as a backpack, messenger bag, shoulder bag, vest, jacket, coat, or shirt.

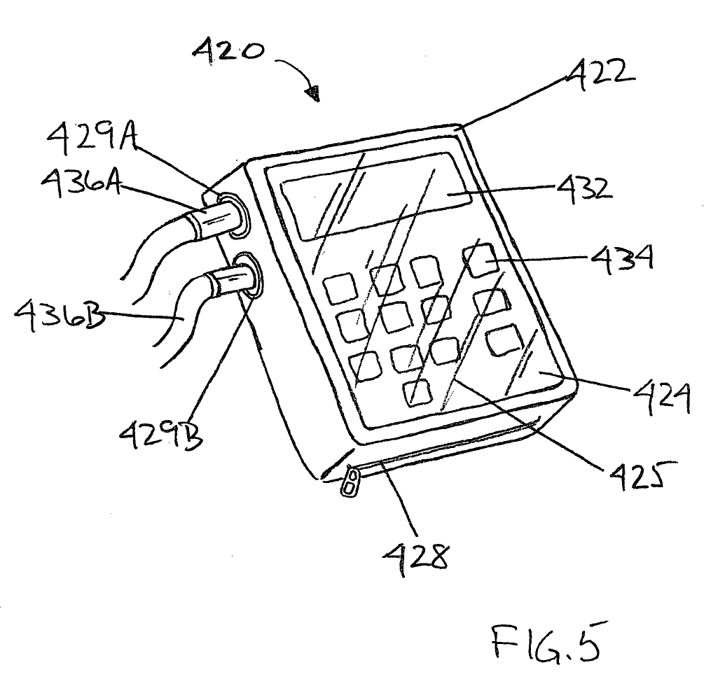

Referring to FIG. 5, pocket 420 comprises a pocket body 422, a first aperture 424, and at least one second aperture 429A-B. First aperture 424 permits observation and/or manipulation of device user interface components, such as display 432 and buttons 434. Second apertures 429A-B permit the passage of an element fixed to the portion of the device enclosed by pocket 420. For example, cables 436A-B are shown attached to the device user interface, and can pass through pocket body 422, so that cables 436A-B reside substantially outside pocket 420. Preferably, the location of second apertures 429A-B in pocket body 422 correspond as closely as possible to the location of cables 436A-B on the device. Optionally, pocket 420 may further comprise a flexible member 425 and/or a securing means 428 as described above with respect to FIGS. 2 and 3.

While this invention has been described in conjunction with the specific embodiments outlined above, it is evident that many alternatives, modifications, and variations will be apparent to those skilled in the art. Accordingly, the embodiments of the invention as set forth above are intended to be illustrative, not limiting. Various changes may be made without departing from the spirit and scope of the invention as defined in the following claims.

1. A carrying apparatus comprising:
a first storage means; and
a second storage means capable of housing an interface portion of a device, the second storage means comprising:
a body capable of substantially enclosing the interface portion of the device; and
an aperture permitting use of the interface portion when it is within the second storage means.

2. The carrying apparatus of claim 1, wherein the second storage means is located on an outer surface of the first storage means.

3. The carrying apparatus of claim 1, further comprising a flexible member covering a portion of the aperture.

4. The carrying apparatus of claim 3, wherein the flexible member is substantially transparent.

5. The carrying apparatus of claim 1, wherein the second storage means further comprises a means for securing the interface portion within the body.

6. The carrying apparatus of claim 1, wherein the apparatus is selected from a group consisting of a backpack, a messenger bag, a shoulder bag, a handbag, a tote bag, and a fanny pack.

7. The carrying apparatus of claim 1, wherein the second storage means is non-fixedly attached to the apparatus.

8. The carrying apparatus of claim 1, further comprising a second aperture permitting passage of an element of the device that is fixed to the interface portion to a location outside the body.

9. A wearable article comprising:
a means for securing the article to a user; and
a means for housing an interface portion of a device, the means comprising:
a body capable of substantially enclosing the interface portion; and
an aperture permitting use of the interface portion when it is within the means for housing.

10. The wearable article of claim 9, wherein the means for housing is located on an outer surface of the article.

11. The wearable article of claim 9, further comprising a flexible member covering a portion of the aperture.

12. The wearable article of claim 11, wherein the flexible member is substantially transparent.

13. The wearable article of claim 9, wherein the means for housing further comprises a means for securing the enclosed interface portion in the body.

14. The wearable article of claim 9, wherein the means for housing is non-fixedly attached to the article.

15. The wearable article of claim 9, wherein the article is intended to be worn on the user's torso.

16. The wearable article of claim 15, wherein the article is selected from a group consisting of a backpack, a messenger bag, a shoulder bag, a vest, a jacket, a coat, and a shirt.

17. The wearable article of claim 9, further comprising a second aperture permitting passage of an element of the device that is fixed to the interface portion to a location outside the body.

18. A storage means comprising:
a body capable of substantially enclosing an interface portion of a device;
a first aperture permitting use of the interface portion when it is within the body; and
a second aperture permitting passage of an element of the device that is fixed to the interface portion to a location outside the body.

19. The storage means of claim 18, further comprising a flexible member covering a portion of the first aperture.

20. The storage means of claim 19, wherein the flexible member is substantially transparent.

21. The storage means of claim 18, further comprising a means for securing the interface portion of the device within the body.
